(19) United States
(12) Patent Application Publication
(10) Pub. No.: US 2009/0226233 A1
(43) Pub. Date: Sep. 10, 2009

(54) PRINT HEAD OF PRINTER AND GAP SPACER USED FOR PRINT HEAD

(75) Inventors: Yasushi Ishikawa, Chiba (JP); Koichi Tanaka, Chiba (JP)

Correspondence Address: HOWARD & HOWARD ATTORNEYS PLLC, 450 West Fourth Street, Royal Oak, MI, 48067, US

(73) Assignee: SEIKO PRECISION INC., Narashino-shi (JP)

(21) Appl. No.: 12/063,054

(22) PCT Filed: Aug. 8, 2006
(86) PCT No.: PCT/JP2006/315673

§ 371 Date: Feb. 6, 2008

(30) Foreign Application Priority Data
Aug. 9, 2005 (JP) 2005-231410

(51) Int. Cl. B41J 2/27

(52) U.S. Cl. 400/124.23

(57) ABSTRACT

An appropriate gap between a yoke plate and a print lever is to be continuously maintained. A gap spacer (24) is inserted between a yoke plate and a print lever (14a). The print lever (14a) abuts a print-lever abutting portion (24b) of the gap spacer (24) in performing printing on a print surface. The gap spacer (24) is provided with notches (24a), so that nine print-lever abutting portions (24b) are separated and independent from one another. Therefore, even if hitting impact is constantly applied from the print lever (14a), no wrinkle is formed in the gap spacer (24), and an appropriate gap between the yoke plate and the print lever (14a) can be appropriately maintained.

### TECHNICAL FIELD

The present invention relates to a print head for a printer, and a gap spacer used for the print head.

### BACKGROUND ART

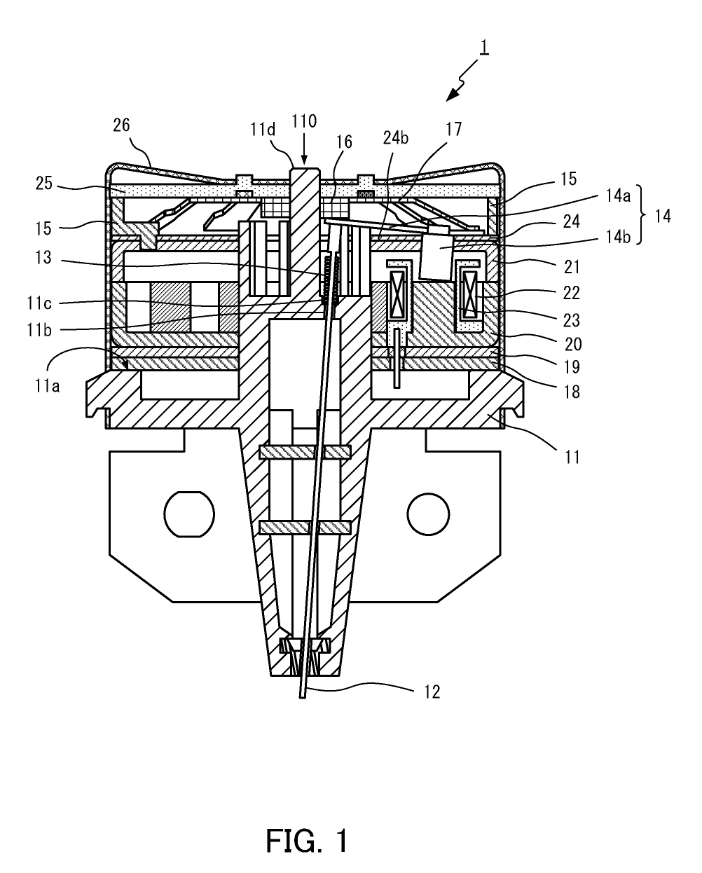

A dot-impact type printer is known as a conventional printer, and a clapper type print head is also known. The print head is a type that a plurality of print levers are electromagnetically driven (see, for example, Unexamined Patent Application KOKAI Publication No. H2-39947 (p. 2 and 3, and FIG. 1)).

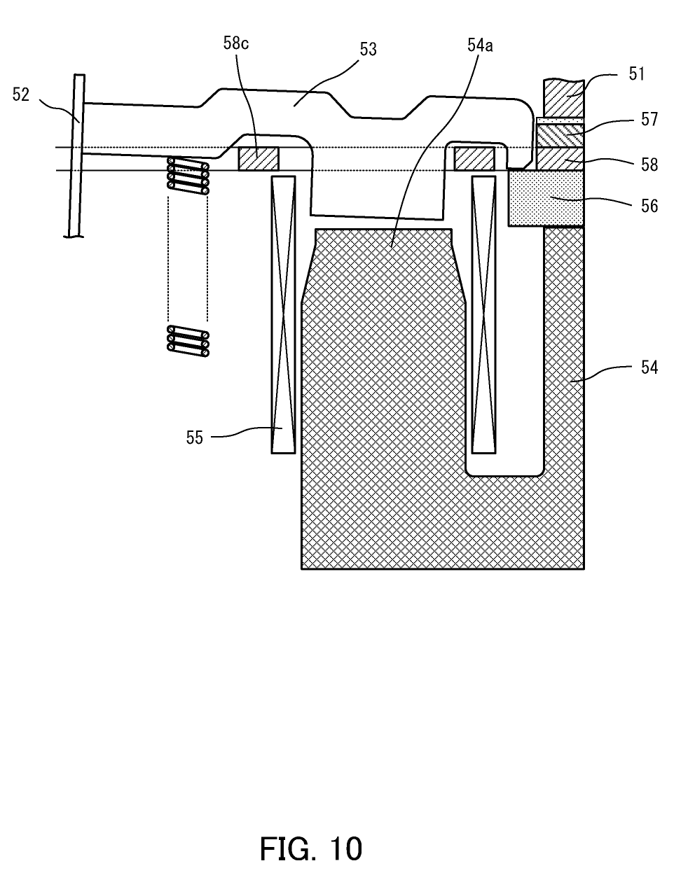

FIG. 10 shows the mechanism of a conventional clapper type print head. As shown in FIG. 10, in the conventional print head, a plurality of print wires 52 are slidably held by a yoke presser frame 51. The rear end portion of each print wire 52 is fixed to the leading end of a print lever 53.

A core 54 is formed of a soft magnetic material, and has iron cores 54a. The end face of the iron core 54a faces the end face of the print lever 53. As a current is supplied to a drive coil 55, the iron core 54a becomes magnetized.

As the iron core 54a is magnetized, the iron core 54a, the print lever 53 and a yoke plate 56 form a magnetic path. The print lever 53 is attracted to the respective iron core 54a, and the print wire 52 is urged toward a print surface direction (downward side in FIG. 10). The print wire 52 protrudes from the print head, and the leading end of the wire is hit against the print surface.

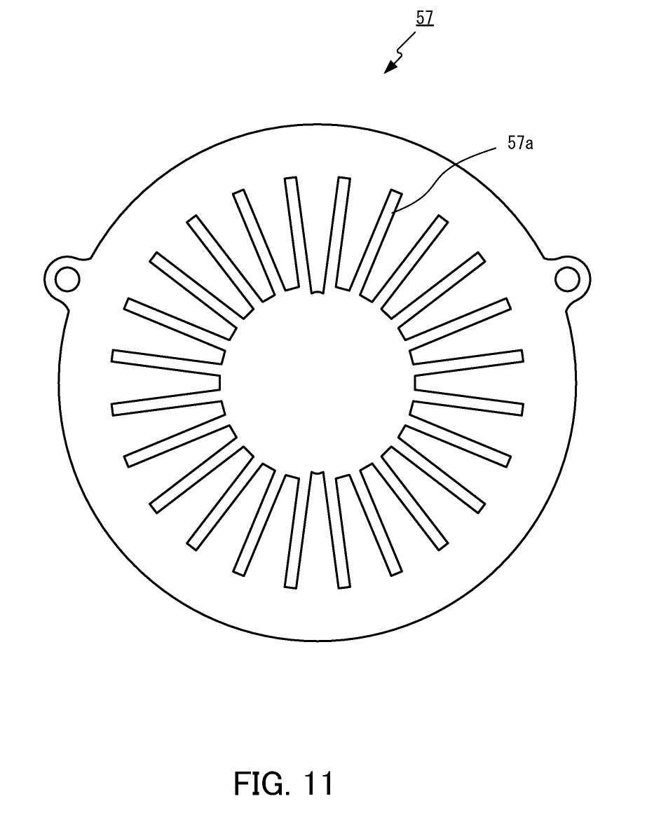

Yoke plates 57, 58 are stacked above the yoke plate 56. As shown in FIG. 11, the yoke plate 57 has a plurality of notches 57a. The print levers 53 are inserted into the respective notches 57a.

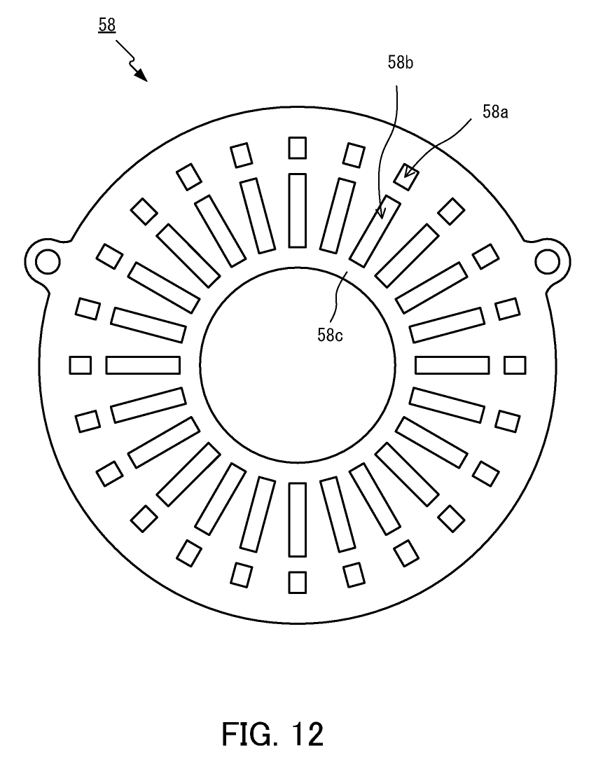

As shown in FIG. 12, the yoke plate 58 has plural holes 58a, plural long holes 58b, and a stopper portion 58c.

The rear end portion of a print lever 53 is inserted into a hole 58a, and this position becomes a support point for the print lever 53. The middle portion of the print lever 53 is inserted into a long hole 58b, thereby fixing the position of the print lever 53. The stopper portion 58c abuts the print lever 53 when the print lever 53 is attracted to the iron core 54a, and suppresses the print lever from hitting the iron core 54a.

### DISCLOSURE OF INVENTION

### Problems to be Solved by the Invention

The print lever 53 repeatedly hits the stopper portion 58c. The yoke plate 58 is formed of a thin tabular metal. Therefore, as the print lever 53 repeatedly hits, the yoke plate 58 gradually deforms.

Wrinkles are formed in the yoke plate 58 due to the deformation of the yoke plate 58. Namely, the stopper portion 58c of the yoke plate 58 is misaligned, thereby forming an overlapped part. Due to the wrinkles, it becomes difficult to maintain an appropriate gap between the yoke plate 58 and the print lever 53, resulting in a difficulty of obtaining appropriate print pressure.

The present invention has been made in view of the foregoing conventional problems, and it is an object of the invention to provide a print head of a printer which can continuously maintain an appropriate gap between a yoke plate and a print lever.

### Means for Solving the Problems

To achieve the object, a print head of a printer according to the first aspect of the invention comprises:
a plurality of print wires each hitting a leading end portion against a print surface to do printing:
a plurality of return springs which urge the respective print wires in a direction opposite to the print surface;
a plurality of print lever mechanism each of which comprises a print lever and a moving yoke, and which is provided for each print wire, the print lever having a leading end portion that abuts a rear end portion of a corresponding print wire, the moving yoke formed of a magnetic material and attached to a rear end portion of the print lever, and the print lever pressing the print wire in a direction of the print surface;
a yoke which is formed of a soft magnetic material, has a plurality of iron cores each having an end face that faces an end face of the respective moving yoke, the magnetized iron core attracting the moving yoke, thereby causing the print lever to urge a corresponding print wire in the direction of the print surface against urging force of the return spring;
a yoke plate which is formed of a soft magnetic material, and forms a magnetic path between the yoke and the moving yoke of each print lever mechanism; and
a gap spacer which is inserted between the plurality of print levers and the yoke plate to set a clearance between the print lever and the yoke plate, and has a plurality of print-lever abutting portion each allowing the attracted print lever to abut, thereby absorbing impact from each print lever to the yoke plate, and wherein
the gap spacer has notches each formed between adjoining ones of the plurality of print-lever abutting portions, and the individual print-lever abutting portions are separated and independent from one another.

To achieve the object, a gap spacer for a print mechanism according to the second aspect of the invention comprises a plurality of print lever mechanisms which have a plurality of print levers pressing respective print wires in a direction of a print surface and moving yokes attached to respective print levers, a yoke which allows iron cores to attract respective moving yokes to urge the print wires in the direction of the print surface, and a yoke plate which forms a magnetic path between the yoke and the moving yoke, the gap spacer is inserted between the plurality of print levers and the yoke plate, and has a plurality of print-lever abutting portions where the respective print levers, attracted to the yoke plate by the moving yokes attracted to the iron cores, abut and wherein
the plurality of print-lever abutting portions of the gap spacer have notches each formed between adjoining print-lever abutting portions, and are separated from one another.

The gap spacer may be formed of a material having smaller coercive force than coercive force of the yoke plate.

It is desirable that the gap spacer should have coercive force formed by a material having a higher strength and flexibility than those of the yoke plate.

For example, a leading end portion of each print-lever abutting portion of the gap spacer is separated from a leading end portion of the adjoining abutting portion by the notch, and the base portion thereof is formed integral with a base portion of the adjoining abutting portion.

For example, each print-lever abutting portion of the gap spacer is formed in a shape having a narrow leading end portion and a wide base portion.

The notch is formed in, for example, a triangular shape which becomes wide at the leading end portion of the print-lever abutting portion, and becomes narrow at the base portion of the print-lever abutting portion.

For example, each print-lever abutting portion of the gap spacer is formed as to be wider than the print lever.

It is desirable that the notch should be formed as to extend to a position near the moving yoke or to a position beyond that position.

The gap spacer comprises, for example, a ring-like member and the plurality of finger-like abutting portions extending from the ring-like member toward a center of the ring.

### EFFECT OF THE INVENTION

According to the invention, because the abutting portion of a print lever is separated away from the abutting portion of an adjoining print lever by a notch, it is possible to continuously maintain an appropriate gap between a yoke plate and a print lever.

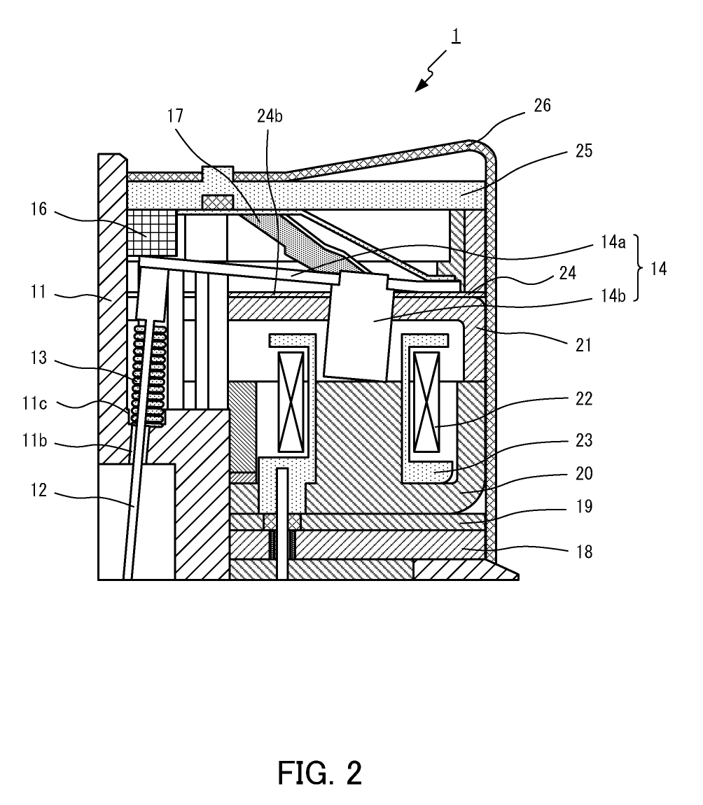

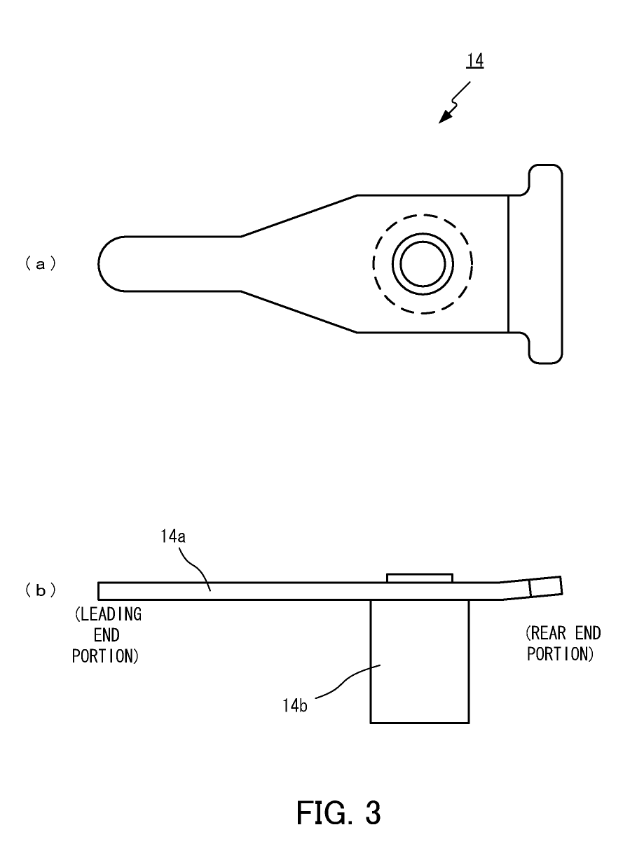

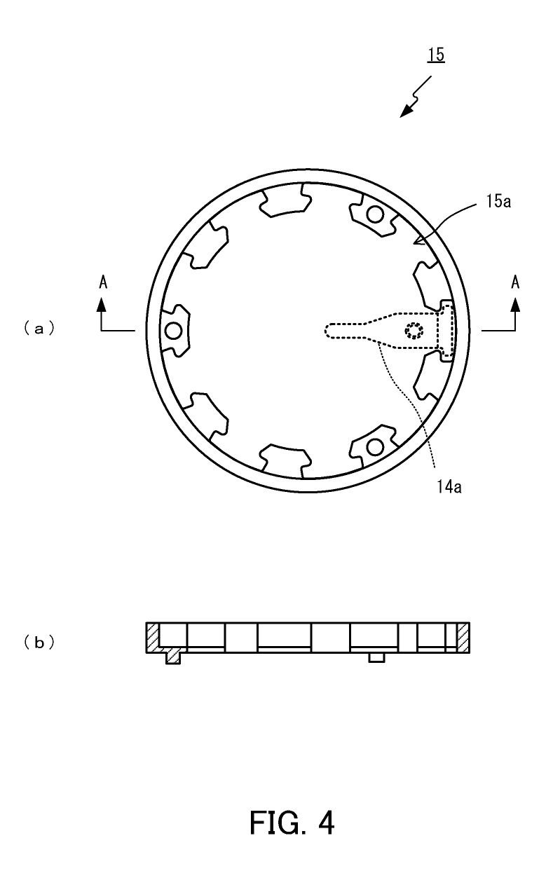

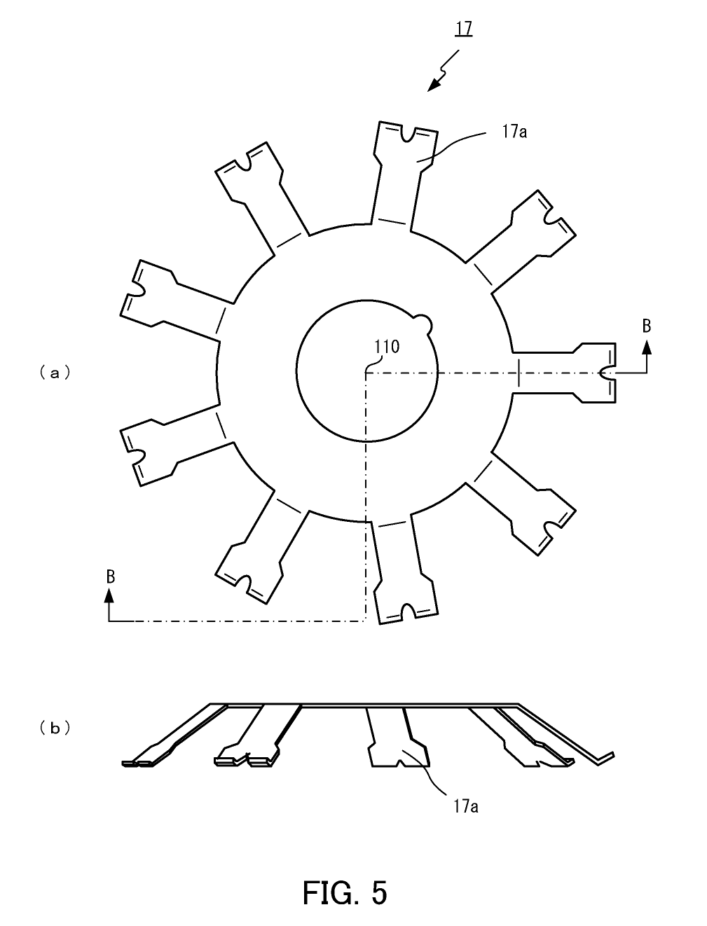

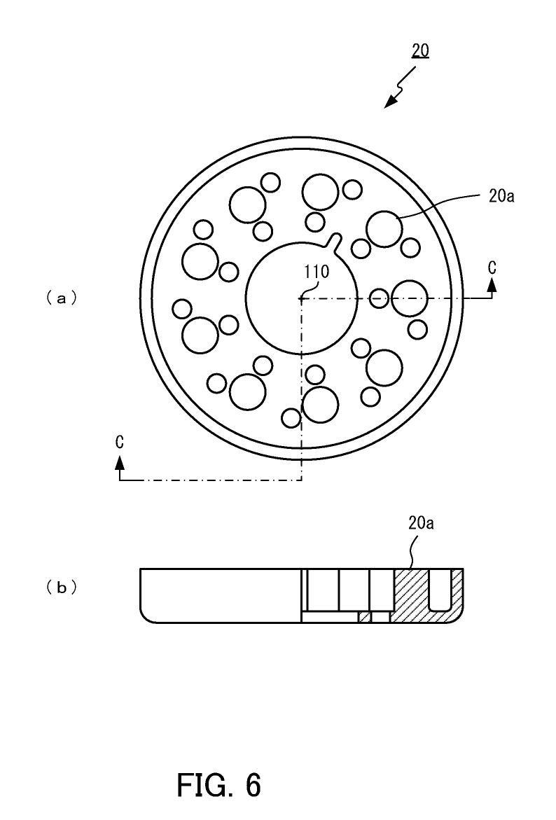

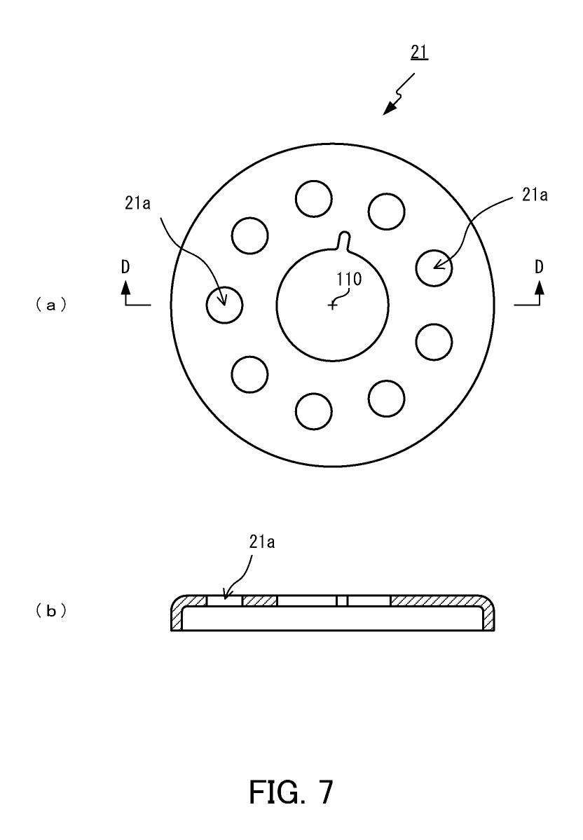

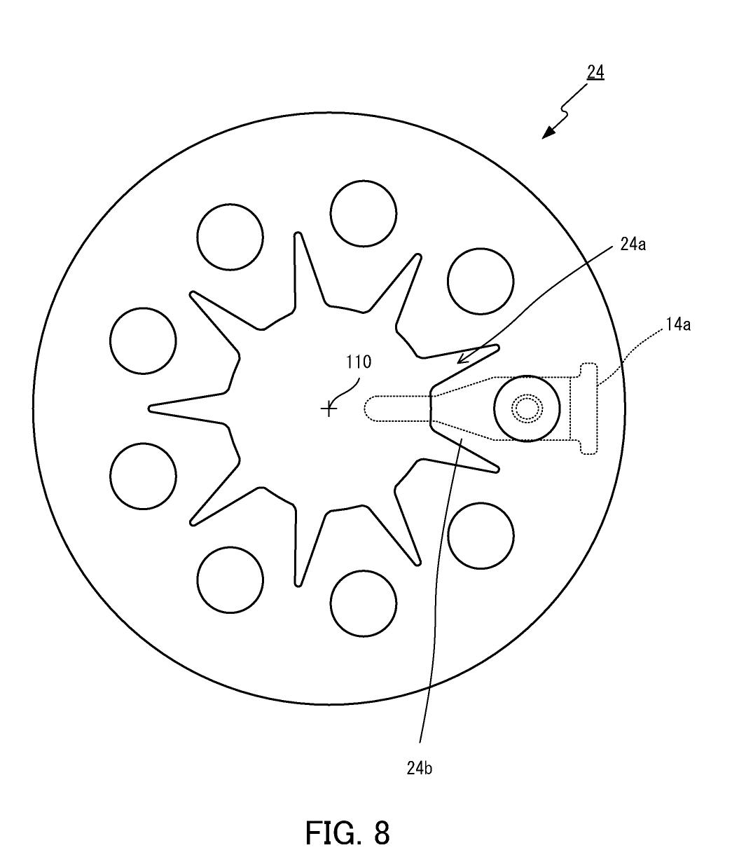

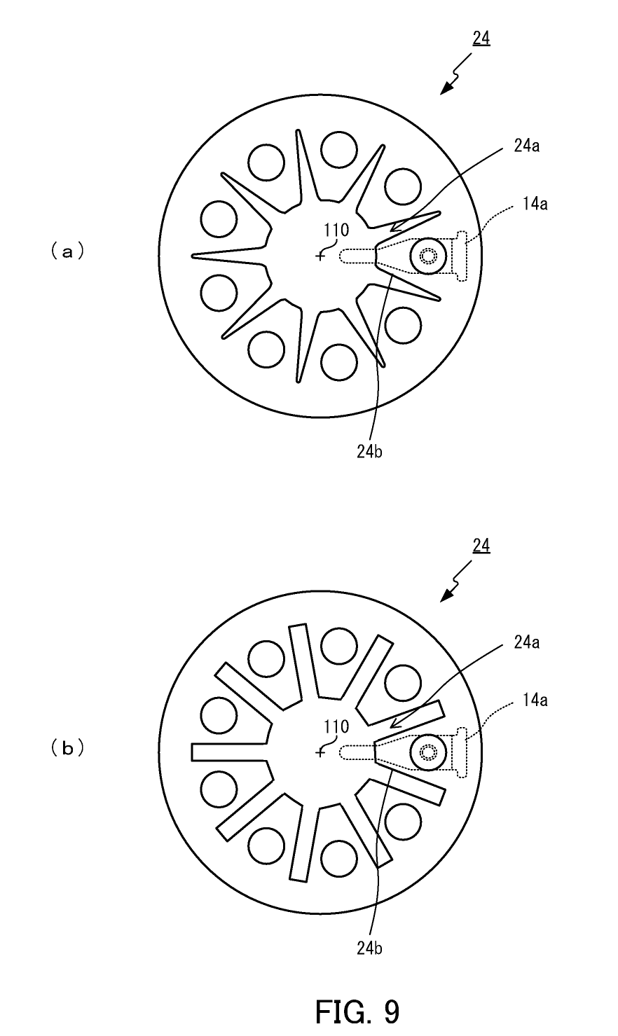

### BRIEF DESCRIPTION OF DRAWINGS

[FIG. 1] A cross-sectional view showing the structure of a print head of a printer according to an embodiment of the invention.

[FIG. 2] A partial enlarged view of FIG. 1.

[FIG. 3] (a) is a plan view and (b) is a side view of a print lever mechanism shown in FIG. 1.

[FIG. 4] (a) is a plan view and (b) is a cross-sectional view of a lever guide shown in FIG. 1.

[FIG. 5] (a) is a plan view and (b) is a cross-sectional view of a lever spring shown in FIG. 1.

[FIG. 6] (a) is a plan view and (b) is a cross-sectional view of a yoke case shown in FIG. 1.

[FIG. 7] (a) is a plan view and (b) is a cross-sectional view of a yoke plate shown in FIG. 1.

[FIG. 8] A plan view of a gap spacer shown in FIG. 1

[FIG. 9] Both (a) and (b) are plan views showing modified examples of the gap spacer shown in FIG. 8.

[FIG. 10] A relevant-part cross-sectional view showing a conventional print head for a printer.

[FIG. 11] A plan view of a yoke plate (1) shown in FIG. 10.

[FIG. 12] A plan view of a yoke plate (2) shown in FIG. 10

### DESCRIPTION OF REFERENCE NUMERALS

1 Print head

11 Wire case

12 Print wire

14 Print lever mechanism

14a Print lever

14b Moving yoke

20 Yoke case

21 Yoke plate

24 Gap spacer

### BEST MODE FOR CARRYING OUT THE INVENTION

Hereinafter, an explanation will be given of a print head for a printer according to an embodiment of the invention with reference to the drawings.

FIG. 1 shows the structure of a print head 1 for a printer according to the embodiment. FIG. 2 is a partial enlarged view of FIG. 1.

The print head 1 for a printer of the embodiment has a wire case 11, print wires 12, return springs 13, print lever mechanisms 14, a lever guide 15, a stopper 16, a lever spring 17, spacers 18, 19, a yoke case 20, a yoke plate 21, a drive coil 22, a bobbin 23, a gap spacer 24, a head cover 25, and a latch spring 26.

The wire case 11 is for setting the components of the print head like the print wires 12, and is formed of, for example, a plastic. The wire case 11 has a lateral cross-section formed in a circular shape with respect to a central axis 110. FIG. 1 shows the cross-section of the wire case 11 in an axial direction. The wire case 11 has a stepped portion 11a for holding individual components, such as the spacers 18, 19, and the yoke case 20.

Formed in the wire case 11 are nine holes 11b for print wires 12 and nine grooves 11c for latching the return springs 13. The nine holes 11b are disposed substantially evenly for each 40° around the central axis 110 of the wire case 11. Each hole 11b is formed in an inclined direction to a print surface, and passes through the wire case 11.

The print wires 12 are for printing and allows the leading end portions thereof to hit against the print surface like a piece of paper for printing. Nine print wires 12 are provided, and inserted into the respective holes 11b formed in the wire case 11. The rear end portion of the print wire 12 is thicker than the leading end portion to efficiently transmit force from the print lever mechanism 14.

The return springs 13 are for urging the respective print wires 12 in a direction opposite to the print surface. Nine return springs 13 are provided for respective nine print wires 12. The return spring 13 comprises a coil spring into which a print wire 12 is inserted. The bottom end portion of the return spring 13 is inserted into a groove 11c of the wire case 11, and held by the wire case 11.

The print lever mechanisms 14 are for hitting the respective print wires 12 against the print surface. The print lever mechanism 14 is formed in, for example, a shape shown in FIGS. 3(a) and (b). FIG. 3(a) is a plan view of the print lever mechanism 14, and FIG. 3(b) is a side view thereof. As shown in FIGS. 3(a) and (b), the print lever mechanism 14 comprises a print lever 14a and a moving yoke 14b. The leading end portion of the print lever 14a abuts the print wire 12. The rear end portion of the print lever 14a protrudes from both sides.

The moving yoke 14b is formed of a soft magnetic material, and is formed in a cylindrical shape. The moving yoke 14b is fixed to the rear end portion of the print lever 14a by, for example, caulking.

The lever guide 15 is for fixing the rear end portion of the print lever 14a. It is formed as to have, for example, a planer shape shown in FIG. 4(a) and a side face shown in FIG. 4(b). FIG. 4(b) is a cross-sectional view along a line A-A in FIG. 4(a). As shown in FIGS. 4(a) and (b), the lever guide 15 is provided with fitting portions 15a. As the fitting portion 15a and the protrusions of the rear end portion of the print lever 14a fit together, the lever guide 15 supports the print lever 14a movable in the vertical direction. The print lever 14a moves in the vertical direction with the fitting portion 15a taken as a support point.

The stopper 16 is for latching the leading end portion of the print lever 14a when the print wires 12 are housed in the wire case 11, and is disposed around an axial portion 11d of the wire case 11.

The lever spring 17 is for holding and latching the rear end portion of the print lever 14a to prevent the rear end portion of the print lever 14a from coming apart from the lever guide 15. The lever spring 17 is formed in, for example, a shape shown in FIGS. 5(a) and (b). FIG. 5(a) is a plan view of the lever spring, and FIG. 5(b) is a cross-sectional view along a line B-B in FIG. 5(a). The lever spring 17 has nine nail portions 17a. The nail portions 17a are respectively disposed around the central axis for each 40° or so. The leading end of each nail portion 17a holds down the rear end portion of the print lever 14a.

The yoke case 20 is for attracting the moving yoke 14b of the print lever mechanism 14 to drive the print lever 14a. The yoke case 20 is formed of, for example, a soft magnetic material, such as electromagnetic soft iron or silicon steel. The yoke case 20 is held on the stepped portion 11 a of the wire case 11 via the spacers 18, 19.

The yoke case 20 is formed in, for example, a shape shown in FIG. 6. FIG. 6(a) is a plan view of the yoke case 20, and FIG. 6(b) is a cross-sectional view along a line C-C in FIG. 6(a). As shown in FIGS. 6(a) and (b), the yoke case 20 has nine iron cores 20a. The iron cores 20a are formed on the yoke case 20 in such a way that the end faces thereof face respective end faces of nine moving yokes 14b of the print lever mechanisms 14. As the yoke case 20 is magnetized, the iron core 20a attracts the moving yoke 14b.

The yoke plate 21 is for forming a closed magnetic path, and is formed of, for example, a soft magnetic material, such as electromagnetic soft iron or silicon steel. For example, the yoke plate 21 is formed in a shape shown in FIGS. 7(a) and (b). FIG. 7(a) is a plan view of the yoke plate 21, and FIG. 7(b) is a cross-sectional view along a line D-D. As shown in FIGS. 7(a) and (b), the yoke plate is provided with nine holes 21a through which the respective moving yokes 14b of the print lever mechanisms 14 pass. The nine holes 21 are formed in the yoke plate 21 around a central axis 110 for each 40° or so.

The drive coil 22 is for magnetizing the yoke case 20 and the yoke plate 21 as a current is supplied thereto. The drive coil 22 is wound on the bobbin 23. The bobbin 23 is formed in such a shape as to surround the circumference of the iron cores 20a of the yoke case 20.

The gap spacer 24 is for maintaining a gap between the yoke plate 21 and the print lever 14a appropriately. A gap spacer 24 having a thickness in accordance with the heights of the yoke case 20 and the yoke plate 21 is used to eliminate the variability in heights between the yoke case 20 and the yoke plate 21.

The gap spacer 24 has following functions.

First, the gap spacer 24 enables the print head 1 to do high speed operation. More specifically, in a case where the print lever 14a is directly disposed on the yoke plate 21, the print lever 14a sticks to the yoke plate 21 because of the remaining magnetism of the yoke plate 21, and is not quickly released from the yoke plate 21. The larger the coercive force is, the larger the remaining magnetism becomes. When such a phenomenon occurs, the operation of the print head 1 becomes slow. As the gap spacer 24 is inserted between the yoke plate 21 and the print lever 14a, the gap spacer 24 reduces the effect of the coercive force of the yoke plate 21, thereby suppressing the occurrence of such a phenomenon.

Second, the gap spacer 24 maintains an appropriate gap between the print lever 14a and the yoke plate 21. When the gaps between the individual print levers 14a and the yoke plate 21 vary, the delays in the operations of the respective print levers 14a due to the remaining magnetism vary. By maintaining the appropriate gap between the print lever 14a and the yoke plate 21, the responsiveness of the print levers 14a are equalized. Further, when the gaps between the individual print levers 14a and the yoke plate 21 vary, the strokes of the print wires also vary, thus causing variability in the print quality. The gap spacer 24 maintains the appropriate gap between the print lever 14a and the yoke plate 21, thereby equalizing the print qualities.

Third, the gap spacer 24 reduces the impact of the print lever 14a to the yoke plate 21. That is to say, when the moving yoke 14b is attracted to the iron core 20a of the yoke case 20, the print lever 14a abuts the gap spacer 24. The yoke plate 21 is formed of, for example, electromagnetic soft iron or silicon steel, and is frangible, so that the gap spacer 24 absorbs the impact force of the print lever 14a to reduce the impact of the print lever 14a to the yoke plate 21, thereby protecting the yoke plate 21.

To make the gap spacer 24 having such functions, used for the gap spacer 24 is a material which has weaker coercive force than that of the yoke plate 21 and has a strength and a flexibility to make the gap spacer to sufficiently withstand even if impact is applied from the print lever 14a. As such a material, austenitic stainless steel is used for the gap spacer 24.

As shown in FIG. 8, the gap spacer 24 has nine print-lever abutting portions 24b where respective print levers 14a abut. The print-lever abutting portion 24b is a part which allows the print lever 14a urged by the yoke case 20 and the yoke plate 21 to abut, and as the print lever 14a abuts the print-lever abutting portion 24b, the impact of the print lever 14a to the yoke plate 21 is absorbed.

The gap spacer 24 is provided with notches 24a between adjoining print-lever abutting portions 24b so as not to have a wrinkle even when impact is applied from the print lever 14a, and is constituted in such a way that the nine print-lever abutting portions 24b where respective print levers 14, one of which is shown in the figure by dashed lines, are separated and independent from one another. More specifically, as shown in FIG. 8, the gap spacer 24 comprises a ring-like rim portion, and the nine finger-like print-lever abutting portions 24b protruding toward the center of the ring from the rim portion. Each print-lever abutting portion 24b is formed in a trapezoidal shape having a narrow leading end and a wide base portion. The leading end portion of each print-lever abutting portion 24b is separated from an adjoining print-lever abutting portion 24b by a notch 24a, and the base portion is formed integral with the base portion of an adjoining print-lever abutting portion 24b. The notch 24a is formed in an approximately triangular shape which becomes wide adjacent to the leading end portion of the print-lever abutting portion 24b, and becomes narrow as the notch becomes deep. Each print-lever abutting portion 24b is so formed as to have a wider width than that of the print lever 14a.

The head cover 25 is for fixing the lever spring 17. The latch spring 26 is for fixing individual components of the print head 1 by pressing down the head cover 25.

The following is an explanation of the operation of the print head 1 for a printer. To cause the print wires 12 to protrude, a current is supplied to the drive coil 22. The iron cores 20a of the yoke case 20 attract the respective moving yokes 14b. As the end face of the moving yoke 14b contacts the end face of the iron core 20a tightly, the yoke case 20, the iron cores 20a, the moving yokes 14b, and the yoke plate 21 form a closed magnetic path.

As the end faces of the moving yokes 14b contact respective end faces of the iron cores 20a tightly, the print levers 14a press the respective print wires 12 against the urging forces of the respective return springs 13. The print wire 12 is pressed by the print lever 14a, and the leading end of the print wire 12 protrudes from the wire case 11, and hits the print surface to do printing.

To return the print wire 12, the current supplied to the drive coil 22 is shut off. As the supplied current is shut off, the magnetic force of the iron core 20a disappears. The return spring 13 urges the print wire 12 in a direction opposite to the print surface. This urging force releases the moving yoke 14b from the iron core 20a, and the leading end portion of the print lever 14a moves to a side opposite to the print surface. The stopper 16 latches the leading end of the print lever 14a.

By repeating such operations, impacts from the print lever 14a is continuously applied to the gap spacer 24. Because the nine print-lever abutting portions 24b of the gap spacer 24 are separated and independent from one another by the notches 24a arranged between adjoining print-lever abutting portions 24b, each print-lever abutting portion is not affected by another print-lever abutting portion 24b. Therefore, no wrinkle is formed in the gap spacer 24, and the gap between the yoke plate 21 and the print lever 14a is maintained appropriately.

As explained above, according to the embodiment, the gap spacer 24 is provided with the notches 24a, so that the nine print-lever abutting portions 24b are structured in such a manner as to be separated and independent from one another.

Accordingly, because the holding positions of individual print levers 14a are ensured independently, even if impact is applied from the print lever 14a to the gap spacer 24 and the print-lever abutting portion 24b is deformed, the individual print-lever abutting portions 24b is not affected by one another. Therefore, no wrinkle is formed in the gap spacer 24, and an appropriate gap between the yoke plate 21 and the print lever 14a is continuously maintained, thereby maintaining the stable performance.

Note that various embodiments can be thinkable to embody the invention, and the invention is not limited to the foregoing embodiment.

For example, the print lever mechanism 14 may have the print lever 14a and the moving yoke 14b formed integral with each other, like the conventional ones. In this case, a yoke plate 58 corresponding to the gap spacer 24 is structured in such a way that stopper portions 58c are separated and independent from one another.

The shapes of the notch 24a and the print-lever abutting portion 24b of the gap spacer 24 shown in FIG. 8 are not limited to ones shown in the figure as long as it prevents the formation of a wrinkle. For example, as shown in FIG. 9(a), the depth of the notch 24a may be deeper than that shown in FIG. 8, and for example, may extend beyond the position of the moving yoke 14b. Note that it is desirable that the notch 24a should be formed near the connection portion of the moving yoke 14b and the print lever 14a, or should be formed deeper than that.

Further, the shape of the innermost end portion of the notch 24a is not limited to an arc-like shape, but may be a rectangular shape as shown in FIG. 9(b). The width of the notch 24a may be uniform as shown in FIG. 9(b).

The shape of the print-lever abutting portion 24b is not limited to a tapered shape, and may be an arbitral shape.

It is desirable that all print-lever abutting portions 24b should be separated and independent from one another, but the notch 24a may be formed for each two or three print-lever abutting portions 24b.

The leading end of the print-lever abutting portion 24b may be also formed in an arc-like shape, or may be formed in a rectangular shape shown in FIG. 9(b). The clearance between the leading ends of the print-lever abutting portions 24b may be smaller than that shown in FIG. 8. The plate thickness at the leading end portion side of the print-lever abutting portion 24b may be thicker or thinner than that at the rear end portion side. By employing such a structure, formation of a wrinkle in the gap spacer 24 is suppressed, and an appropriate gap can be maintained. The material of the gap spacer 24 is not limited to austenitic stainless steel, and may be a metal other than stainless if it has durability. The gap spacer 24 may be formed of a material other than metal.

The structures of the components other than the gap spacer 24 can be changed and modified arbitrarily. For example, in FIG. 1, the print wire 12 is urged by the return spring 13 to urge the print wire 12 in a direction opposite to the print surface, but like the conventional example shown in FIG. 10, the print lever 14a itself may be urged.

It is to be noted that the disclosed embodiment is just for exemplification and is not for limitation. The scope of the invention is indicated not by the foregoing explanation but by the appended claims, and it is intended that equivalences and all changes within the scope of the invention should be included.

This application is based on Japanese Patent Application No. 2005-231410 filed on Aug. 9, 2005. The entire specification, claims, and drawing of Japanese Patent Application No. 2005-23410 should be incorporated in this specification by reference.

### INDUSTRIAL APPLICABILITY

According to the invention, it is possible to continuously maintain an appropriate gap between a yoke plate and a print lever. The frequency of replacing a component is reduced, thereby extending the Mean Time Between Failure (MTBF).

1. A print head of a printer comprising:
a plurality of print wires each hitting a leading end portion against a print surface to do printing;
a plurality of print lever mechanism each of which comprises a print lever and a moving yoke and is provided for each print wire, the moving yoke being attached to the print lever, and the print lever pressing the print wire in a direction of the print surface;
a yoke which has a plurality of iron cores facing respective moving yokes of the print lever mechanisms, the magnetized iron core attracting the moving yoke, thereby causing the print lever to urge the print wire in the direction of the print surface;
a yoke plate which is formed of a soft magnetic material, and forms a magnetic path between the yoke and the moving yokes of the individual print lever mechanisms; and
a gap spacer which is inserted between the plurality of print levers and the yoke plate to set a clearance between the print lever and the yoke plate, and has a plurality of print-lever abutting portions each allowing the attracted print lever to abut to absorb impact of the print lever to the yoke plate, and wherein
the gap spacer has notches each formed between adjoining ones of the plurality of print-lever abutting portions, and the individual print-lever abutting portions are separated and independent from one another.

2. The print head of a printer according to claim 1, wherein the gap spacer is formed of a material having smaller coercive force than coercive force of the yoke plate.

3. The print head of a printer according to claim 1, wherein the gap spacer is formed of a material having a higher strength and flexibility than those of the yoke plate.

4. The print head of a printer according to claim 1, wherein a leading end portion of each print-lever abutting portion of the gap spacer is separated from a leading end portion of the adjoining abutting portion by the notch, and the base portion thereof is formed integral with a base portion of the adjoining abutting portion.

5. The print head of a printer according to claim 4, wherein each print-lever abutting portion of the gap spacer is formed in a shape having a narrow leading end portion and a wide base portion.

6. The print head of a printer according to claim 4, wherein the notch is formed in a triangular shape which becomes wide at the leading end portion of the print-lever abutting portion, and becomes narrow at the base portion of the print-lever abutting portion.

7. The print head of a printer according to claim 1, wherein each print-lever abutting portion of the gap spacer is formed as to be wider than the print lever.

8. The print head of a printer according to claim 1, wherein the notch is formed as to extend to a position near the moving yoke or to a position beyond that position.

9. The print head of a printer according to claim 1, wherein the gap spacer comprises a ring-like member and the plurality of finger-like abutting portions extending from the ring-like member toward a center of the ring.

10. A gap spacer for a print mechanism, which comprises a plurality of print lever mechanisms having a plurality of print levers pressing respective print wires in a direction of a print surface and moving yokes attached to respective print levers, a yoke allowing iron cores to attract respective moving yokes to urge the print wires in the direction of the print surface, and a yoke plate forming a magnetic path between the yoke and the moving yoke, the gap spacer being inserted between the plurality of print levers and the yoke plate, and having a plurality of print-lever abutting portions where the respective print levers, attracted to the yoke plate by the moving yokes attracted to the iron cores, abut and wherein
the plurality of print-lever abutting portions of the gap spacer have notches each formed between adjoining print-lever abutting portions, and are separated from one another.

11. The gap spacer according to claim 10, wherein the gap spacer is formed of a material having smaller coercive force than coercive force of the yoke plate.

12. The print head of a printer according to claim 10, wherein the gap spacer has coercive force formed by a material having a higher strength and flexibility than those of the yoke plate.

13. The gap spacer according to claim 10, wherein a leading end portion of each print-lever abutting portion is separated from a leading end portion of the adjoining abutting portion by the notch, and the base portion thereof is formed integral with a base portion of the adjoining abutting portion.

14. The gap spacer according to claim 13, wherein each print-lever abutting portion is formed in a shape having a narrow leading end portion and a wide base portion.

15. The gap spacer according to claim 14, wherein the notch is formed in an approximately triangular shape which becomes wide at the leading end portion of the print-lever abutting portion, and becomes narrow at the base portion of the print-lever abutting portion.

16. The gap spacer according to claim 10, wherein each print-lever abutting portion is formed as to be wider than the print lever.

17. The gap spacer according to claim 10, wherein the notch is formed as to extend to a position near the moving yoke or to a position beyond that position.

18. The gap spacer according to claim 10, wherein the gap spacer comprises a ring-like member and the plurality of finger-like abutting portions extending from the ring-like member toward a center of the ring.
